(19) United States
(12) Patent Application Publication
(10) Pub. No.: US 2003/0046383 A1
(43) Pub. Date: Mar. 6, 2003

(54) Method and system for measuring network performance from a server

(75) Inventors: Alfred M. Lee, Seattle, WA (US); NK Srinivas, Sammamish, WA (US); Christian Huitema, Clyde Hill, WA (US); Bernard D. Aboba, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 09/947,181

(22) Filed: Sep. 5, 2001

(51) Int. Cl. G06F 15/173; G06F 15/16

(52) U.S. Cl. 709/224; 709/203

(57) ABSTRACT

A system and method for measuring the performance of a network, such as the Internet, uses a server on the network to collect network performance data in the process of servicing clients on the network. When the server receives a data transfer request from a client, it records operation information such as the time it takes to transfer the requested data, the size of the data, etc. and derives performance evaluation data such as round-trip time, bandwidth, packet loss, etc. that indicate network performance between the client and the server. The recorded performance data for the multiple clients are aggregated and analyzed together with client information to determine the network performance experienced by the clients.

### TECHNICAL FIELD OF THE INVENTION

This invention relates generally to computer networks, and more particularly to a method and system for measuring and analyzing the network performance between two points on a network, such as the Internet.

### BACKGROUND OF THE INVENTION

In the last decade, the Internet has transformed from a network used mainly by researchers in academia and laboratories into a truly global network that has changed many aspects of our lives. When the World Wide Web came into being in 1993, Internet usage exploded, and it continues to grow at an amazing rate. Numerous Web sites have been set up by organizations, business entities, and individuals to provide various types of services. Everyday, millions of people use the Internet to exchange e-mail, get news, check stock prices, purchase goods, and search for information, etc.

With the many Web sites on the Internet competing for the attention of Internet users, it is of critical importance to a Web site to ensure that it can promptly respond to communication requests of Internet clients and deliver the requested services to the clients. A Web site that is perceived by Internet clients as too slow or difficult to form a reliable communication connection is likely to lose those clients quickly to competing Web sites.

In this context, the network performance experienced by a client in communicating with a Web server depends on not only how promptly the server can process the client's request, but also how long it takes to transfer requested data through the Internet to the client. The latter component of the perceived network performance is determined by the quality of the network connection between the server and the client. Due to the critical importance of maintaining high network performance to the success of a Web site, there is a strong need for a mechanism for evaluating the performance of the network between the Web server and the Internet clients.

The standard approach to measuring the network performance in the context of accessing a Web site is to perform the measurements on the client side. Under this approach, a client computer is used to access a target Web server. In the course of communicating with the server, the client records data pertaining to service delivery by the server, such as round-trip times and bandwidths (e.g., bytes delivered divided by time taken) for data transfer. As an example, one system used by many Web sites for performing network performance measurements is the Keynote system. The Keynote system has a plurality of distributed agents located in different metropolitan areas. To measure the network performance experienced by clients of a given Web site, each agent downloads a file of a given size from that Web site. The time it takes to download the file from the Web site to the agent is recorded as an indicator of the network performance perceived by clients of that Web site. In order to provide relatively up-to-date network performance information, the measurements are performed periodically, such as every 15 minutes.

Although the measurements by the Keynote agents are very useful for monitoring the network performance for clients of the Web site, that approach has some significant limitations. The measurements performed by the agents are only statistical samples that roughly suggest the kind of network performance likely to be experienced by real network clients, rather than the actual network performance experienced by those clients. Also, the measurements performed by each agent only generally reflect the network performance experienced by clients that are similarly situated in terms of geographic locations and network connections. Due to the high costs of deploying a large number of agents, the measurements are limited to selected areas. As a result, the measured data collected by the agents may not provide a comprehensive picture of how well the communications between the server and all the clients on the Internet are carried out. Moreover, the agents perform the network performance measurement by downloading files from the target servers, and such downloading increases the workload of the web site and the network traffic carried by the Internet.

### SUMMARY OF THE INVENTION

In view of the foregoing, the present invention provides a system and method for measuring and analyzing the performance of a network, such as the Internet, connecting a server with one or more clients, that allows efficient collection of comprehensive performance data without the problems associated with conventional network performance measurements. In sharp contrast to the conventional approach of performing network performance measurements on the client side, data used to evaluate the network performance perceived by the clients are actually collected by the server in the course of servicing communication requests from the clients on the network. When the server receives a request for data from the client, it records operation information in connection with the transfer of the requested data over the network to the client. The server than evaluates the network performance perceived by the client by generating network performance evaluation (or metric) data from the operation information collected.

In the specific context of the Internet, the network server is a Web server that serves multiple Internet clients, which may be located at different geographic locations and using different network connections. For each client, the Web server records operation data in connection with communications with that client under the TCP/IP protocol, such as the IP address of the client, the time taken to transfer a data object through the Internet to the client, and the size of the transferred data object, the average round-trip time, etc.

For a server providing services to multiple clients on the network, the operation information and the performance evaluation data generated by the server for the multiple clients can be aggregated, and the aggregated data can be analyzed together with the client information in various ways and presented in different forms for diagnoses and other purposes. The network performance evaluation data collected by multiple servers on the network may also be aggregated to provide a more comprehensive picture of the network performance.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system on which the present invention may reside;

FIG. 2 is a schematic diagram showing an embodiment of a system for measuring network performance experienced by clients of a Web server on the Internet that uses the Web server to collect performance measurement data;

FIG. 3 is a schematic diagram showing a communication sequence between a client on the Internet and the Web server; and

FIG. 4 shows an exemplary distribution curve of time taken to download a file from a Web server versus number of Internet clients that downloaded the file.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

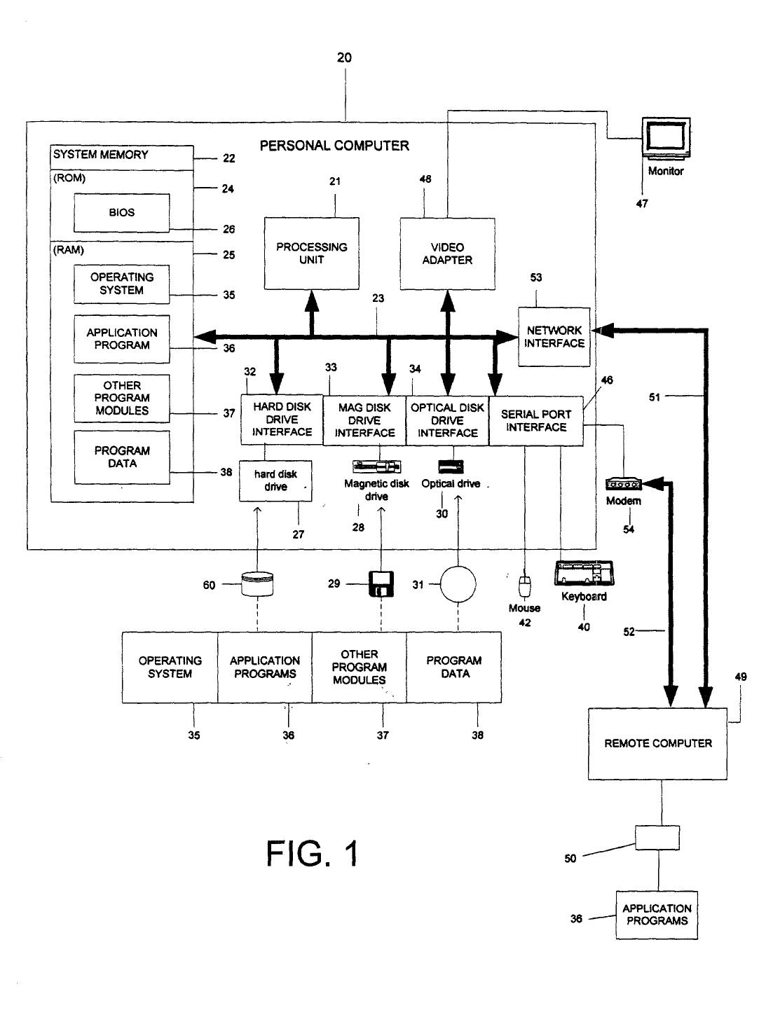

With reference to FIG. 1, an exemplary computer system for implementing the invention includes a general purpose-computing device in the form of a conventional personal computer 20, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system-memory includes read only memory (ROM) 24 and random access memory (RAM) 25. A basic input/output system (BIOS) 26, containing the basic routines that help to transfer information between elements within the personal computer 20, such as during start-up, is stored in ROM 24. The personal computer 20 further includes a hard disk drive 27 for reading from and writing to a hard disk 60, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer readable instructions, data structures, program modules and other data for the personal computer 20. Although the exemplary environment described herein employs a hard disk 60, a removable magnetic disk 29, and a removable optical disk 31, it will be appreciated by those skilled in the art that other types of computer readable media which can store data that is accessible by a computer, such as magnetic cassettes, flash memory cards, digital video disks, Bernoulli cartridges, random access memories, read only memories, and the like may also be used in the exemplary operating environment.

A number of program modules may be stored on the hard disk 60, magnetic disk 29, optical disk 31, ROM 24 or RAM 25, including an operating system 35, one or more applications programs 36, other program modules 37, and program data 38. A user may enter commands and information into the personal computer 20 through input devices such as a keyboard 40 and a pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial bus (USB). A monitor 47 or other type of display device is also connected to the system bus 23 via an interface, such as a video adapter 48. In addition to the monitor, personal computers typically include other peripheral output devices, not shown, such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the person computer 20 typically includes a modem 54 or other means for establishing communications over the WAN 52. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

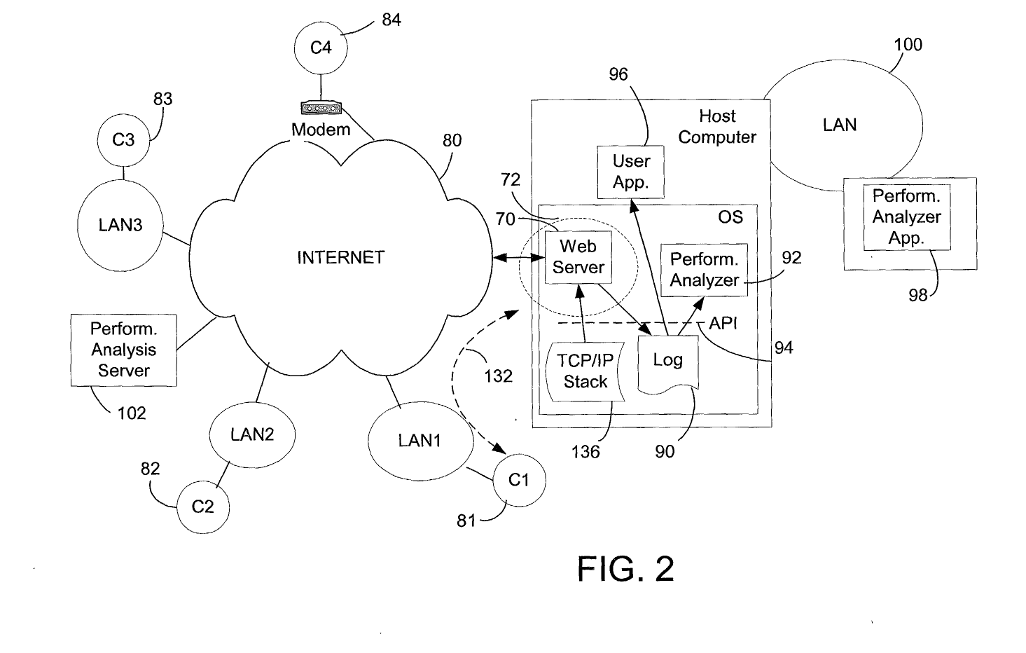

Referring now to FIG. 2, the present invention is directed to a system and method for measuring the performance of a network as experienced by a client on a computer network, especially the Internet, relating to communications between the client and a server on the network. The network performance measurement of the invention has significant advantages over the conventional approach of performing network performance measurements on the client side. According to the invention, communication operation data relevant to the network performance are collected by the server in the course of servicing communication requests from clients on the network. When the server receives a request from a client for a data transfer, it collects operation information in connection with transferring the requested data to that client. The operation information is then used to generate the values of predefined performance evaluation data (or metrics) indicative of the network performance experienced by the client of the server. Some types of communication operation information may, of course, be used directly as the values of selected performance evaluation metrics. The operation information may be, for example, the time it takes for sending the requested data over the network and the amount of data sent. The performance metrics, for example, may be the averaged bandwidth and the round-trip time of the data transfer between the server and client, the data loss rate, etc. The performance metric data for multiple clients and servers can be aggregated, and the aggregated data can be analyzed together with client information in various forms of statistical analyses to yield network connectivity information for the clients.

In the following description, the invention will be described in the particular context of measuring client-perceived network performance on the side of a server on the Internet. The Internet, being the most important global wide-area computer network, is clearly an intended environment for the application of the invention. It will be appreciated, however, that the approach of measuring client-perceived network performance on the server side in accordance with the invention can be advantageously applied to other computer networks, which may be intranets, local-area networks, or wide-area networks.

In the embodiment shown in FIG. 2, the server 70 is a Web server for a Web site 72 on the World Wide Web of the Internet 80. The Web server 70 may be accessed by different clients 81-84 connected to the Internet. For simplicity of illustration, only several clients are shown. The clients communicate with the Web server 70 under the Transmission Control Protocol/Internet Protocol (TCP/IP), which includes the Hypertext Transfer Protocol (HTTP) for transferring Web pages from the server to the clients. For a given client, the network performance experienced by that client in the context of communicating with the server 70 can be generally defined as how quickly the client can receive data it requested from the server.

Performance between two points on a network is determined by many factors. For example, even though the client and server may have very high bandwidth connections to their local network (e.g., 100 Mbit/sec or better), the client may still experience poor network performance. This is because low-bandwidth wide-area connections, congestion on any one of the many typically intervening links between points on the Internet, etc., all can cause degradation of network transfer rate and effective bandwidth. Similarly, the number of routers, physical distances, and congestion all affect the average round trip time between two points on a network. While the focus of a preferred embodiment has been on TCP/IP network connections, other protocols, e.g., User Datagram Protocol (“UDP”) streams used for streaming audio and video, may also be sensitive to packet loss rates (number of packets dropped along a given network path) in determining network performance.

A client's perception of a particular network application's performance may be more sensitive to some network performance characteristics than others. For example, average bandwidth, round trip time (RTT), packet loss, some combination of these, or other related metrics like maximum guaranteed bandwidth (e.g., during a one-hour period, what is the maximum bandwidth certain to be available during any and all 30-second windows), or maximum RTT, (highest RTT seen during a measurement window), etc., may be important to perceived network performance.

In accordance with the invention, these network performance measurement data are collected on the Web server, but provide information about the client's experience of the application. In this regard, the term “Web service” is used to refer broadly to applications that have a significant component delivered over a network to the client. A standard Web site is one such Web service, but many other are possible, including applications were the client of the Web service is another server, which in turn delivers the application functionality to an end-user.

In this context, the network performance is determined not only by how fast the server can process the client's request, but also by the quality and capacity of the network connection between the client and server for sending the data through the Internet to the client. Thus, in the case that the server processing time is negligible, the perceived Web service performance actually reflects how well the Internet handles the network traffic between the server and the client. Since the clients may be located in different geographic locations and reside on different computer networks, and linked to the Internet with different communication media, the performance of the network as experienced by the clients in communicating with the Web server can vary significantly from client to client. As described in greater detail below, the server-side performance measurement in accordance with the invention allows the network performance evaluation data to be collected on a per-client basis for many different clients, thereby enabling comprehensive and in-depth analyses of the network performance.

In the embodiment of FIG. 2, the Web server 70 maintains a log 90 into which the operation data are stored. The stored operation data may be retrieved from the log 90 and converted into or used directly as performance metric values by another operating system application, such as the performance analyzer component 92, through provided functions of an application-programming interface (API) 94. Alternatively, the data may be retrieved and used to derive the performance metrics by a user application 96. The aggregated performance metric data for different clients or across multiple servers may then be analyzed in many different ways to present a picture of the network performance between the servers and the clients. The performance analyses may be performed, for example, by the operating system application 94 or the user application 96, or another application 98 residing on a different computer in a private network 100 on which the server 70 resides. Alternatively, the measured performance metric data may be transmitted to a remote server 102 on the Internet 80 that is specialized in analyzing the performance data measured by different servers. For instance, the server 102 may belong to a service that collects performance metric data for different Web sites and provides reports containing diagnostic information or suggestions for improving the performance of those Web sites.

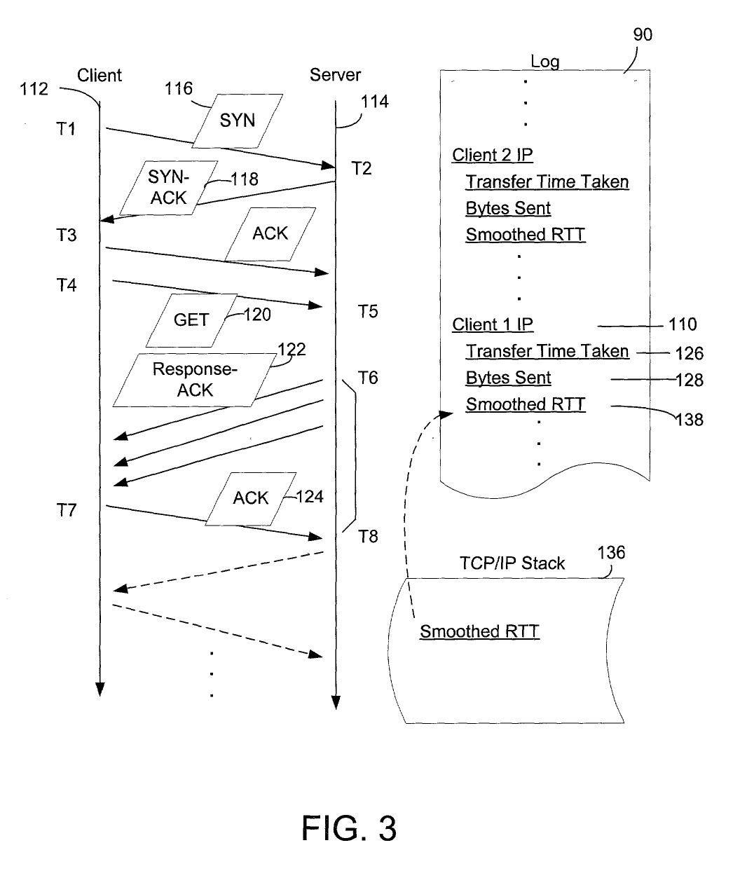

Turning now to FIG. 3, in one implementation, the operation data recorded by the Web server in the log 90 for a given client includes the client's IP address, various time intervals involved in transferring data objects from the server to the client, and the sizes of the data objects transferred. For illustration purposes, FIG. 3 shows a temporal sequence of communications between the client and the server under the TCP/IP. The timing of the communication events is identified with reference to the two parallel time lines 112 and 114. The initial handshake phase between the server and client includes the sending of a SYN packet 116 by the client to the server, and the returning of a SYN-ACK packet 118 by the server to the client. The client's IP address is written by the server into a “Client IP” field 110 in the log 90. Thereafter, the client sends a GET request 120 for downloading data objects, such as Web pages in the HTML language or other types or files. When the server receives the GET request, it records the time (T5) the request is received and processes the request. When the requested data are ready, the server begins transmitting the data through the Internet to the client and records the time (T6) when the data transmission begins. The interval between T5 and T6 represents the server processing time in response to the download request. When the client receives the response data 122 sent by the server, it returns an ACK packet 124 acknowledging the receipt of the data. The ACK 124 is transmitted through the Internet to the server. When the server receives the ACK packet 124, it records the time (T8) of receipt. The interval between T4 and T7 is the client's measurement of total transfer time, which combines server and network delays. To within small statistical fluctuations in network delivery time between the GET 120 and ACK 124, the server-measured time interval T5 to T8 will be the substantially the same as the interval T4 to T7. For the current Internet, the measured data for these two intervals have been shown to be the same to within better than 15 milliseconds for greater than 99% of transfers.

On the server, the interval T5 to T8 can be decomposed into the server processing time (T5 to T6), and the network transfer time, T6 to T8. As illustrated in FIG. 3, the T6 to T8 interval is written by the server into a “Transfer Time Taken” field 126 in the log 90. The server also writes the size of the transferred object into a “Bytes Sent” field 128 in the log. A TCP connection 132 (FIG. 2) between the client 81 and the server 70 may span the downloading of several objects, and the server preferably writes the “Transfer Time Taken” and “Bytes Sent” values for each downloaded object into the log. For each object, the averaged bandwidth of the data transfer may be derived by dividing the “Bytes Sent” value with the “Transfer Time Taken” value. This averaged bandwidth per object transferred indicates the quality of the network connection between the client and the server. Since the response time of the Web server is perceived by the client as the sum of the processing time of the server and the time it takes for the downloaded data to pass through the Internet to the client, the averaged bandwidth is a useful performance metric for evaluating the network performance experienced by the client of the Web server.

Besides the download time and the size for each downloaded data object, the server may write into the log other data that are pertinent to the quality of the client-server communication connections. It will be appreciated that some of the recorded data may be used directly as performance metrics, and others may be used to derive performance metrics as in the case of the averaged bandwidth.

By way of example, in the illustrated embodiment, the communication connection 132 between the Web server 70 and the Internet client 81 is established under the TCP/IP, and the operating system of the server maintains a TCP/IP stack 136. One piece of information stored in the TCP/IP stack is a “smoothed Round-trip time” (smoothed RTT), which represents the time to send one packet from the server to the client, or the reverse, and get back an acknowledgment. This smoothed RTT is for each TCP connection and thus can be reported by the client's IP address. It is a useful estimate for latency, which is an important performance metric for transaction-oriented web sites. Latency is the length of time to send a small amount of information (usually less than 1500 bytes so that it fits in one network packet) between two points on the Internet. For transaction oriented services, e.g., purchasing a ticket or checking the availability of a book, the round trip latency determines largely the perceived performance. While average bandwidth is determined by the number and size of packets that can be sent per second between two points, Latency is determined by factors including the physical distance, router queuing, and packet loss along the route. For example, the speed of light sets a minimum round trip time of one half second for a network path that uses a geo-synchronous satellite. While this is a fairly long RTT, the same path may have 100 Mbit/sec average bandwidth available, which is a high value. Thus, the latency and bandwidth data together allow a better understanding of the perceived network performance.

In a preferred implementation, for each object downloaded to the client, the server obtains from the TCP/IP stack the smoothed RTT that is in effect when the last byte transferred is acknowledged by the client, and writes it into a “Smoothed RTT” field 138 in the log. To that end, the operating system provides functions in the API 94 (FIG. 2) for the server to access the TCP/IP stack to retrieve the smoothed RTT data. Another network characteristic available from the TCP/IP stack is packet loss rate. The TCP is designed to retry, if a sent packet is not acknowledged in a timely fashion. In the same way RTT is recorded per client IP address, the number of packets re-tried and packets sent can be recorded. The number of packets sent to the client and the number of packets lost in communication between the server and the client can be retrieved from the TCP/IP stack. The ratio of these two numbers provides the packet loss rate. These can then be exposed for logging and analysis, both during the TCP session for time averages, and at the end for session averages, on a client-by-client basis.

Other server protocols have the potential to expose packet loss and other network performance metrics. For example, a media streaming server can use UDP for transfer. While UDP does not directly expose packet losses, RTT, or average bandwidth metrics, the media player on the client cooperates with the streaming server to report packet loss information. The streaming server could expose this loss rate information per client, together with the streaming bandwidth, to provide detailed information about network connectivity between the server and client.

One important aspect of the invention is that network performance evaluation data may be generated by the server on a per-client basis, i.e., for each of the clients that access the server. There are at least three major advantages associated with this aspect. First, as the clients are the “real” clients served by the server, the performance data collected by the server reflect the real network performance experienced by the clients, rather than merely samples like those generated by the agents of the existing Keynote system. Second, since the performance data are collected by the server in the course of serving real clients, as opposed to stand-in agents, the measurements do not generate extra traffic on the Internet or increase the number of client requests to be responded by the server.

Third, since the measurements are performed for real clients from diverse geographic locations with different network connections, the server has a wealth of client information against which the performance data may be analyzed. Based on the client's IP address, grouping clients by geography, Internet service provider, and network connectivity is possible, allowing identification of network issues that affect various subgroups of a service's client base. An application may also decide to expose other client identification information for more detailed per client network evaluation and additional aggregation groups. For example, a web server could record in a log client identification information (cookies) in addition to the IP address, transfer time, and size of a transfer.

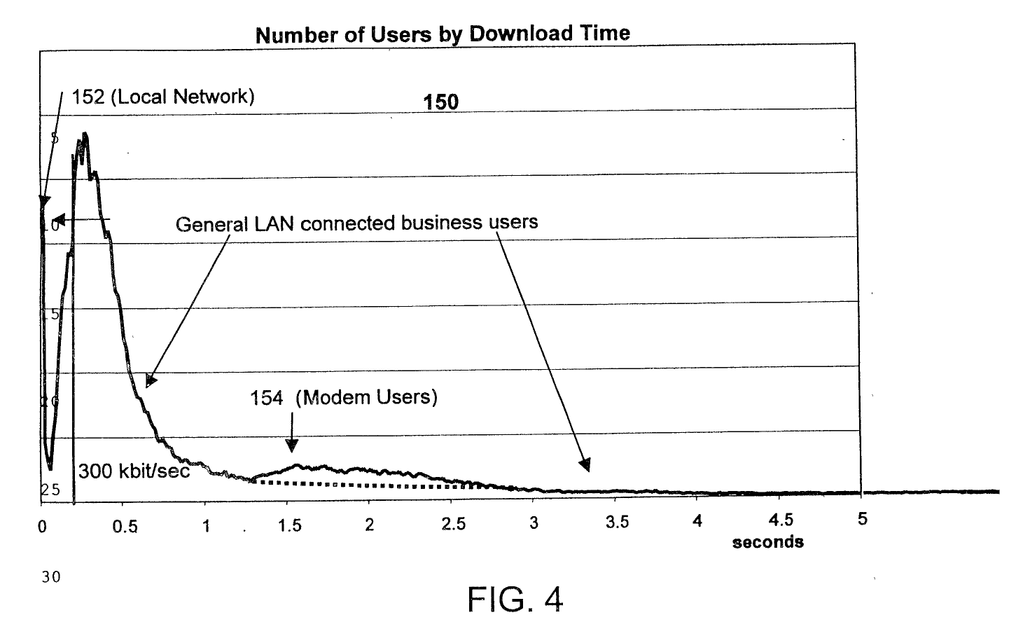

After the performance metric data for multiple clients are aggregated, they can be analyzed in many different ways against the client information for diagnostic and planning purposes. By way of example, FIG. 4 shows a distribution curve 150 that plots the average time for downloading a file from a server of a selected web site versus the number of clients that downloaded that file. The size of the file is about 9 kilobytes. The peak 152 in the curve near zero download time is associated with clients that are on the same corporate internal network with the server and thus have the fastest network connections to the server and the shortest download times. The remaining portion of the curve is largely associated with business users that are connected to the Internet via their respective local-area networks (LANs). A bump 154 in the curve centered about two (2) seconds of download time can be identified as being associated with users that connect to the Internet via modems. It can be seen that even a simple analysis of the measured performance data like the one shown in FIG. 4 can provide valuable information about how well the clients are served by the server.

There are, of course, various other ways to analyze the measured performance metric data against the client information and various ways to present the results of the analyses. Based on the client information, the performance data may be analyzed against clients associated with different organizations, network media, geographic locations, etc. For example, if it is found that clients in particular geographic area have experienced exceedingly low bandwidths or high loss rates, a decision may be made to investigate any possible problems with the network connections to that area.

In view of the many possible embodiments to which the principles of this invention may be applied, it should be recognized that the embodiment described herein with respect to the drawing figures is meant to be illustrative only and should not be taken as limiting the scope of invention. For example, those of skill in the art will recognize that the elements of the illustrated embodiment shown in software may be implemented in hardware and vice versa or that the illustrated embodiment can be modified in arrangement and detail without departing from the spirit of the invention. Therefore, the invention as described herein contemplates all such embodiments as may come within the scope of the following claims and equivalents thereof.

What is claimed is:

1. In a network having a server connected to at least one client, a method of evaluating performance of the network as perceived by the client communicating with the server, comprising the steps of:
receiving, by the server, a request for data transfer from the client;
transferring, by the server, requested data through the network to said client in response to the request;
collecting, by the server, operation information in connection with the transferring; and
generating, by the server, network performance evaluation data based on the collected operation information for indicating network performance as perceived by the client.

2. A method as in claim 1, wherein the operation information collected in connection with the transferring of the requested data to the client includes data representing time taken for transferring the requested data to the client and a size of the requested data.

3. A method as in claim 1, wherein the network performance evaluation data include a smoothed round-trip time for communications between the server and the client.

4. A method as in claim 3, wherein the step of generating includes retrieving from a TCP/IP stack data representing the smoothed round-trip time.

5. A method as in claim 1, wherein the network performance evaluation data include a packet loss rate for communications between the server and the client, and wherein the step of collecting includes retrieving from a TCP/IP stack data representing a number of packets sent to the client and a number of packets lost in communication between the server and the client for deriving the packet loss rate.

6. A method as in claim 1, wherein the network performance evaluation data include an averaged bandwidth for transferring the requested data to the client.

7. A method as in claim 1, including performing the steps of receiving, transferring, collecting, and generating for each of a plurality of clients, and further including the step of aggregating the network performance evaluation data for the plurality of clients for analysis together with client information of the plurality of clients.

8. A method as in claim 7, further including the step of transferring the aggregated network performance evaluation data to a second server on the network for analysis.

9. A method as in claim 7, wherein the client information includes network addresses of the plurality clients.

10. A computer-readable medium having computer-executable instructions for a server on a network to performs steps for evaluating performance of the network as perceived by a client communicating with the server over the network, the steps comprising:
receiving a request for data transfer from the client;
transferring requested data through the network to said client in response to the request;
collecting operation information in connection with the transferring; and
generating network performance evaluation data based on the collected operation information for indicating network performance as perceived by the client.

11. A computer-readable medium as in claim 10, wherein the operation information collected in connection with the transferring of the requested data to the client includes data representing time taken for transferring the requested data to the client and a size of the requested data.

12. A computer-readable medium as in claim 10, wherein the network performance evaluation data include a smoothed round-trip time for communications between the server and the client.

13. A computer-readable medium as in claim 12, wherein the step of generating includes retrieving from a TCP/IP stack data representing the smoothed round-trip time.

14. A computer-readable medium as in claim 10, wherein the network performance evaluation data include a packet loss rate for communications between the server and the client, and wherein the step of collecting includes retrieving from a TCP/IP stack data representing a number of packets sent to the client and a number of packets lost in communication between the server and the client for deriving the packet loss rate.

15. A computer-readable medium as in claim 10, wherein the network performance evaluation data include an averaged bandwidth for transferring the requested data to the client.

16. A computer-readable medium as in claim 10, having computer-executable instructions for performing the steps of receiving, transferring, collecting, and generating for each of a plurality of clients, and aggregating the network performance evaluation data for the plurality of clients for analysis together with client information of the plurality of clients.

17. A computer-readable medium as in claim 16, having further computer-executable instructions for performing the step of transferring the aggregated network performance evaluation data to a second server on the network for analysis.

18. A computer-readable medium as in claim 16, wherein the client information includes network addresses of the plurality of clients.

19. A system for evaluating network performance experienced by a plurality of Internet clients communicating with a Web site, comprising:
a service component of the Web site for serving the plurality of Internet clients, the service component receiving a request for data transfer from each of the plurality of Internet clients, transferring requested data through the Internet to said each Internet client in response to-the request, collecting client information data and generating network performance evaluation data in connection with the transferring of the requested data to said each Internet client;
a performance evaluating application for aggregating network performance evaluation data collected by the service component for the plurality of Internet clients and analyzing the aggregated network performance data together with the client information data.

20. A system as in claim 19, wherein the performance evaluating application receives the network performance evaluation data collected by the service component through a network connection from the Web site.

21. A system as in claim 19, wherein the Web server collects the network performance evaluation data in connection with the transferring of the requested data to said each Internet client by recording operation data representing time taken for transferring the requested data to said each Internet client and a size of the requested data.

22. A system as in claim 19, wherein the network performance evaluation data include a smoothed round-trip time.

23. A-system as in claim 22, wherein the service component retrieves the smoothed round-trip time from a TCP/IP stack.

24. A system as in claim 19, wherein the network performance evaluation data include a packet loss rate for communications between the service component and said each Internet client.

25. A system as in claim 19, wherein the network performance data include an averaged bandwidth for transferring said requested data to said each Internet client.

26. A system as in claim 19, wherein the client information data include an IP address of said each Internet client.

27. A system for evaluating network performance experienced by a plurality of clients communicating with a server over a network, comprising:
a service component of the server for serving the plurality of clients, the service component receiving a request for data transfer from each of the plurality of clients, transferring requested data through the network to said each client in response to the request, collecting client information data and generating network performance evaluation data in connection with the transferring of the requested data to said each client;
a performance evaluating application for aggregating network performance evaluation data collected by the service component for the plurality of clients and analyzing the aggregated network performance data together with the client information data.

28. A system as in claim 27, wherein the performance evaluating application receives the network performance evaluation data collected by the service component over a network connection with the server.

29. A system as in claim 27, wherein the service component collects the network performance evaluation data in connection with the transferring of the requested data to said each client by recording operation data representing time taken for transferring the requested data to said each client and a size of the requested data.

30. A system as in claim 27, wherein the network performance evaluation data include a smoothed round-trip time.

31. A system as in claim 30, wherein the service component retrieves the smoothed round-trip time from a TCP/IP stack of the server.

32. A system as in claim 27, wherein the network performance evaluation data include a packet loss rate for communications between the service component and said each client.

33. A system as in claim 27, wherein the network performance data include an averaged bandwidth for transferring said requested data to said each client.

34. A system as in claim 27, wherein the client information data include network addresses of the plurality of clients.
